(19) United States
(12) Patent Application Publication
(10) Pub. No.: US 2010/0302479 A1
(43) Pub. Date: Dec. 2, 2010

(54) OPTICAL ARTICLE

(76) Inventors: Joseph T. Aronson, Menomonie, WI (US); Stephen J. Etzkorn, Woodbury, MN (US); Mark E. Gardiner, Santa Rosa, CA (US); Eric W. Nelson, Stillwater, MN (US); Tri D. Pham, Oakdale, MN (US); Haiyan Zhang, Woodbury, MN (US)

Correspondence Address: 3M INNOVATIVE PROPERTIES COMPANY, PO BOX 33427, ST. PAUL, MN, 55133-3427, US

(21) Appl. No.: 12/744,545

(22) PCT Filed: Dec. 9, 2008
(86) PCT No.: PCT/US08/86078

§ 371 Date: Aug. 6, 2010

Related U.S. Application Data
(60) Provisional application No. 60/013,782, filed on Mar. 21, 1996.

(51) Int. Cl. G02F 1/13357; G02B 1/04; B32B 3/30; G02B 5/02

(52) U.S. Cl. 349/64; 428/141; 359/599

(57) ABSTRACT

The invention provides optical articles (11) having a microstructured surface wherein the microstructured surface has randomly distributed recesses (14) thereon and wherein the microstructured surface and the recesses are unitary, that is, the recesses are formed directly in microstructures. Optical displays utilizing the optical articles described herein are also disclosed.

### RELATED APPLICATIONS

This application claims the benefit of U.S. Provisional Patent Application No. 61/013,782, filed on Dec. 14, 2007, the disclosure of which is incorporated by reference herein in its entirety.

### BACKGROUND

The invention relates to optical articles having a microstructured surface.

The use of a variety of structured surface films in displays is well known. Such films are used to enhance the apparent brightness or visual uniformity of the displays. In general, the increase in on-axis brightness produced by such films is known as the “gain” of the film. The on-axis gain of a film refers to the ratio of the intensity of light as measured in a direction perpendicular to the light source with the structured film to the intensity of the light, observed in the same manner, without the structured film.

One of the problems with using such structured films in certain displays is that small defects can be visible to the viewer. One solution has been to provide the film with a diffuser. This may be a matte finish on the smooth side, the structured side, or both, of the film, or a bulk diffuser provided in the film. However, such approaches scatter the light and thus decrease on-axis gain. Another solution has been to use a beaded diffuser on the backside of a structured film. However, this approach requires that a manufacturer of such films handle beaded compositions which can be complex to apply in a uniform coating to obtain the best results.

Other backlit displays, for example some LCD monitors and LCD televisions (LCD-TVs), are directly illuminated from behind using a number of light sources positioned behind the display panel. This latter arrangement is increasingly common with larger displays because the light power requirements, needed to achieve a certain level of display brightness, increase with the square of the display size, whereas the available real estate for locating light sources along the side of the display only increases linearly with display size. In addition, some display applications, such as LCD-TVs, require that the display be bright enough to be viewed from a greater distance than other applications. In addition, the viewing angle requirements for LCD-TVs are generally different from those for LCD monitors and hand-held devices.

Many LCD monitors and LCD-TVs are illuminated from behind by a number of cold cathode fluorescent lamps (CCFLs). These light sources are linear and stretch across the full width of the display, with the result that the back of the display is illuminated by a series of bright stripes separated by darker regions. Such an illumination profile is not desirable, and so a diffuser plate is typically used to smooth the illumination profile at the back of the LCD device.

A diffuse reflector is used behind the lamps to direct light towards the viewer, with the lamps being positioned between the reflector and the diffuser. The separation between the diffuse reflector and the diffuser is limited by the desired brightness uniformity of the light emitted from the diffuser. If the separation is too small, then the luminance becomes less uniform, thus spoiling the image viewed by the viewer. This comes about because there is insufficient space for the light to spread uniformly between the lamps.

### SUMMARY

The invention provides optical articles that provide both an acceptable level of gain and diffusion. In one aspect, the present disclosure provides an optical article that includes an optical film including a substrate having a microstructured surface, where the microstructured surface has randomly distributed recesses on the microstructured surface, and where the microstructured surface and the recesses are unitary.

### BRIEF DESCRIPTION OF THE DRAWINGS

FIGS. 1a-1d are computer generated cross-sections of tapping mode Atomic Force micrographs of optical film samples of the invention;

FIG. 2a is a perspective view of an illustrative optical article of the invention;

FIG. 2b is a cross-sectional view of an illustrative optical article of the invention having prism elements of varying heights;

FIG. 2c is a cross-sectional view of an illustrative optical article of the invention having prism elements of varying heights;

FIG. 2d is a cross-sectional view of an illustrative optical article of the invention having prism elements of varying heights;

FIG. 2e is a cross-sectional view of an illustrative optical article of the invention having prism elements of varying heights;

FIG. 2f is a cross-sectional view of an illustrative optical article of the invention having prism elements that are canted;

FIG. 2g is a cross-sectional view of an illustrative optical article of the invention;

FIG. 2h is a cross-sectional view of an illustrative optical article of the invention;

FIG. 2i is a perspective view of an illustrative optical article of the invention;

FIG. 2j is a perspective view of an illustrative optical article of the invention;

FIG. 2k is a cross-sectional view of an illustrative optical article of the invention;

FIG. 2l is a cross-sectional view of an illustrative optical article of the invention;

FIG. 3 is a perspective view of an illustrative optical article of the invention;

FIGS. 4a and 4b are a partial plan view and cross section of an illustrative optical article of the invention having discrete microstructures;

FIGS. 5-9 are digital images of scanning electron images of the optical articles of Examples 1-5, respectively;

FIGS. 10a and 10b are plots of the oscillation of the relative luminance versus position for the optical films of Examples 5 and 6, respectively, and a comparative example; and

FIGS. 11-15 are digital images of scanning electron microscope images of the optical articles of Examples 6-10, respectively.

### DETAILED DESCRIPTION

The term “microstructure” means the configuration of a surface that depicts or characterizes the predetermined desired utilitarian purpose or function of the article having the microstructure. Discontinuities, e.g., projections, in the surface of said article will deviate in profile from the average center line drawn through the microstructure such that the sum of the areas embraced by the surface profile above the center line is equal to the sum of the areas below the line, said line being essentially parallel to the nominal surface (bearing the microstructure) of the article. The heights of said deviations will typically be about 0.2 to 750 micrometers, as measured by an optical or electron microscope, through a representative characteristic length of the surface, for example, 1-30 cm. Said average center line can be plano, concave, convex, aspheric or combinations thereof. Articles where said deviations are of low order, for example, from 0.005 to 0.1 or, in another embodiment, 0.05 micrometers, and said deviations are of infrequent or minimal occurrence, that is, the surface is free of any significant projections, are those where the microstructure-bearing surface is an essentially “flat” or “smooth” surface.

A microstructured surface is a surface having at least one microstructure. In some embodiments, the microstructured surface comprises linear microstructures, random microstructures, pseudo-random microstructures, discrete microstructures, canted microstructures, or a combination of any of them.

The microstructures and randomly distributed recesses of the optical article of the invention are unitary, that is, the recesses are formed into the microstructures, for example, via a molding process, and no additional material is added to the surface of the microstructures to enable or enhance formation of recesses. In some embodiments of the optical articles of the invention, the “randomness” of the distribution of the recesses is within a repeating pattern. This is due to the configuration of the mold used to provide such a microstructured surface and its repeated use.

The shapes and sizes of the recesses vary depending upon the type of metal that is electroplated onto a roll mold. The shapes and sizes of the recesses are the reverse of the shapes and sizes of the metal structures plated onto the roll. Such shapes include those that resemble pores, semi-hemispheres, “jagged” valleys, “craters,” and the surface of cauliflower. Recesses may overlap, be within one another, or be isolated from one another. The sizes of the recesses may vary with the height and pitch of the microstructures. For example, the sizes of recesses are typically smaller than the microstructures such that the sizes of the recesses do not overwhelm the size of the microstructures. The sizes, that is, largest diameter, of the recesses can range from about 0.5 micrometers to about 125 micrometers at their largest diameter. A typical range is from 0.5 to 15 micrometers. Areas of the recesses can range from about 0.01 to about 1100 square micrometers. Depths can range from about 0.2 to about 20 micrometers.

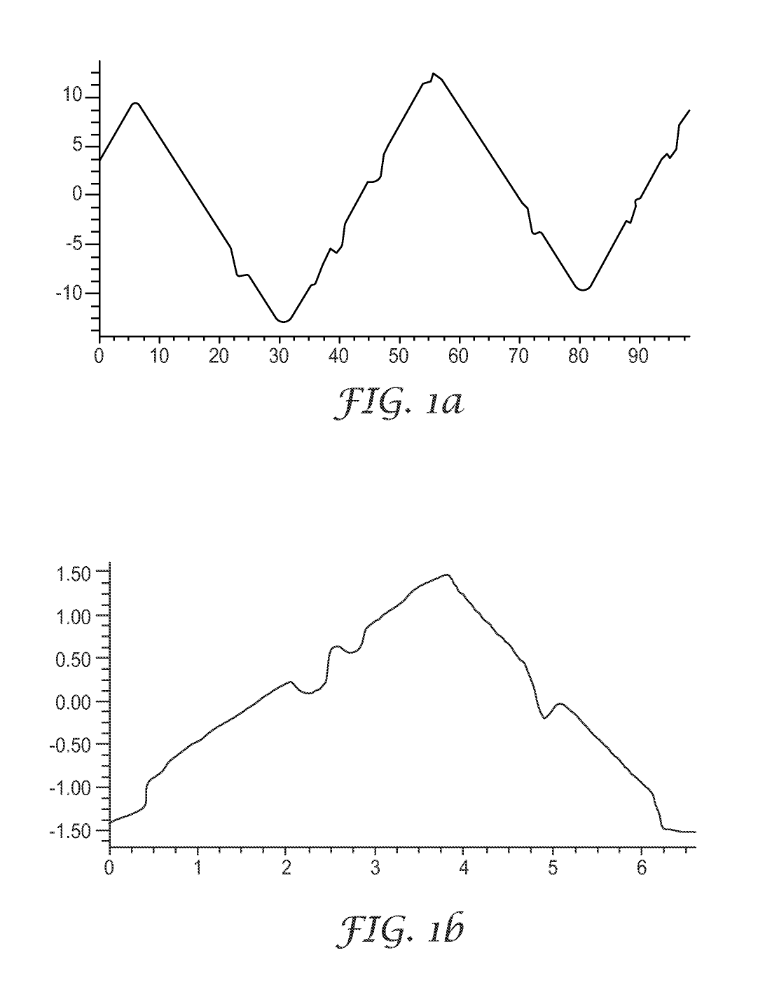

The recesses are defined relative to the “original” surface or plane of the microstructures. That is, the recesses are deviations that are below the original surface or plane of the microstructures. To further illustrate “recesses,” FIGS. 1a-1d show computer generated cross-sections of tapping mode Atomic Force micrographs of optical film samples of the invention wherein the microstructures are prism-shaped. FIGS. 1a and 1b illustrate a microstructure having a low or minimum density of recesses while FIGS. 1 c and 1 d illustrate a high or maximum density of recesses on a microstructure.

The optical articles of the invention have been found to have certain advantages over prior optical films having microstructured surface. Among those advantages, the optical articles of the invention provide improved light diffusion over typical bead-coated backside diffusion coating; can be made in a single manufacturing step as compared to articles having a diffusion coating; eliminate the need to expertly make high quality diffusion layers or coatings containing beads, which can reduce scrap; in some applications, allow for the elimination of a separate diffusion sheet, for example, in large LCD displays; improve uniformity in direct lit LCD modules; and minimize optical structure damage or defects due to beads when optical films are stacked.

Generally, the optical articles are used in optical devices which comprise a light source and a light gating device, such as a liquid crystal display device. The optical articles are used to direct light from the light source to the light gating device. Examples of light sources include electroluminescent panels, light guide assemblies, and fluorescent or LED backlights.

The optical articles of the invention can be used as brightness enhancement films, uniformity films, turning films, image directing films (refracting beam redirecting product) or gain diffusers depending upon the configuration of the microstructured surface. The optical articles of the invention can also be stacked such that the microstructures, for example, elongated prism elements, are orthogonal to one another, or stacked such that the microstructures on each article are aligned at any angle relative to the other.

Generally, an optical article having a microstructured surface with randomly distributed recesses (for example, a brightness enhancing film) can be prepared by a method including the steps of (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed flexible base substrate and the master; and (d) curing the composition. In this case, the microstructured surface and the substrate are separate layers bonded together.

Another method is directly replicating the mold onto an extruded or cast substrate material, resulting in a substrate and microstructured surface that is monolithic.

In order to form the recesses on the microstructured surface, in one embodiment, a microstructured roll is subjected to an electroplating process. Metal accretes inhomogeneously on the microstructured surface of the roll, forming protuberances. The microstructured surface of the optical film replicates with pores or pits, etc., relative to the microstructured surface of the roll. The size and density of the metal structures deposited onto the microstructured roll via the electroplating process is determined by the current density, the roll face speed, and the plating time. The type of metal salt used in the electroplating process determines the geometry of the deposited metal structures, and thus, determines the shape of the recesses on the microstructured surface. The location and disposition of the deposited metal structures on the microstructured roll is random.

The master molding surface can be metallic, such as nickel, nickel-plated copper or brass. One or more of the surfaces of the base layer or substrate can optionally be primed or otherwise be treated to promote adhesion of the microstructured surface layer to the substrate.

The microstructured surface can directly contact the substrate or be optically aligned to the substrate, and can be of a size, shape and thickness that allows the microstructured surface to direct or concentrate the flow of light. The microstructured surface can have any of a number of useful patterns such as described and shown in the FIGURES. The microstructured surface can be a plurality of parallel longitudinal ridges extending along a length or width of the substrate. These ridges can be formed from a plurality of prism apexes. These apexes can be sharp, rounded, flattened, or truncated. For example, the ridges can be rounded to a radius in a range of 4 to 7 to 15 micrometers. The microstructured surface can be integrally formed with the substrate or can be formed from a material and adhered or laminated to the substrate. The pitch of the microstructures can be at least 5 micrometers and not more than 250 micrometers and can vary from 5 to 250 micrometers. In other embodiments, the pitch of the microstructures can vary from 5 to 150 micrometers, 5 to 100 micrometers, 5 to 50 micrometers, and 5 to 25 micrometers.

The regular or irregular prismatic patterns can be an annular prismatic pattern or any other lenticular microstructure. A useful microstructure is a regular prismatic pattern that can act as a totally internal reflecting film for use as a brightness enhancement film. Another useful microstructure is a prismatic pattern that can act as an optical element for use in an optical display. Another useful microstructure is a prismatic pattern that can act as an optical turning film or element for use in an optical display.

Materials useful for making the microstructures adhered to the substrate include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; unsaturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds.

The substrate can be of a nature and composition suitable for use in an optical product, that is, a product designed to control the flow of light. Almost any material can be used as a substrate material as long as the material is sufficiently optically clear and is structurally strong enough to be assembled into or used within a particular optical product. A substrate material can be chosen that has sufficient resistance to temperature and aging such that performance of the optical product is not compromised over time. The substrate may be uniaxially or biaxially oriented.

The particular chemical composition and thickness of the substrate material for any optical product can depend on the requirements of the particular optical product that is being constructed, e.g., balancing the needs for strength, clarity, temperature resistance, surface energy, adherence to the microstructured surface, ability to form a microstructured surface, among others.

Useful substrate materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, and glass. Optionally, the substrate material can contain mixtures or combinations of these materials. In an embodiment, the substrate may be multi-layered or may contain a dispersed phase suspended or dispersed in a continuous phase.

For some optical products such as brightness enhancement films, examples of desirable substrate materials include polyethylene terephthalate (PET) and polycarbonate. Examples of useful PET films include photograde polyethylene terephthalate and MELINEX™ PET available from DuPont Films of Wilmington, Del.

In some embodiments, the substrate, the microstructured surface, or both may contain or incorporate diffusing particles throughout its thickness. The diffusing particles may be any type of particle useful for diffusing light, for example transparent particles whose refractive index is different from the surrounding polymer matrix, diffusely reflective particles, or voids or bubbles in the matrix. Examples of suitable diffusely reflecting particles include particles of titanium dioxide (TiO₂), calcium carbonate (CaCO₃), barium sulphate (BaSO₄) and the like. The diffusing particles may be distributed with uniform or graded concentration throughout the thickness, or may be patterned, for example, to provide greater diffusion above a light source and less diffusion between light sources, for improved uniformity. The diffusive particles may also be coated on the back or flat side of the optical article.

Some substrate materials can be optically active, and can act as polarizing materials. A number of substrates, also referred to herein as films or substrates, are known in the optical product art to be useful as polarizing materials. Polarization of light through a film can be accomplished, for example, by the inclusion of dichroic polarizers in a film material that selectively absorbs passing light. Light polarization can also be achieved by including inorganic materials such as aligned mica chips or by a discontinuous phase dispersed within a continuous film, such as droplets of light modulating liquid crystals dispersed within a continuous film. As an alternative, a film can be prepared from microfine layers of different materials. The polarizing materials within the film can be aligned into a polarizing orientation, for example, by employing methods such as stretching the film, applying electric or magnetic fields, and coating techniques.

Examples of polarizing films include those described in U.S. Pat. Nos. 5,825,543 and 5,783,120, each of which are incorporated herein by reference. The use of these polarizer films in combination with a brightness enhancement film has been described in U.S. Pat. No. 6,111,696, incorporated by reference herein.

A second example of a polarizing film that can be used as a substrate are those films described in U.S. Pat. No. 5,882,774, also incorporated herein by reference. Films available commercially are the multilayer films sold under the trade designation DBEF (Dual Brightness Enhancement Film) from 3M. The use of such multilayer polarizing optical film in a brightness enhancement film has been described in U.S. Pat. No. 5,828,488, incorporated herein by reference.

This list of substrate materials is not exclusive, and as will be appreciated by those of skill in the art, other polarizing and non-polarizing films can also be useful as the base for the optical products of the invention. These substrate materials can be combined with any number of other films including, for example, polarizing films to form multilayer structures. A short list of additional substrate materials can include those films described in U.S. Pat. Nos. 5,612,820 and 5,486,949, among others. The thickness of a particular base can also depend on the above-described requirements of the optical product.

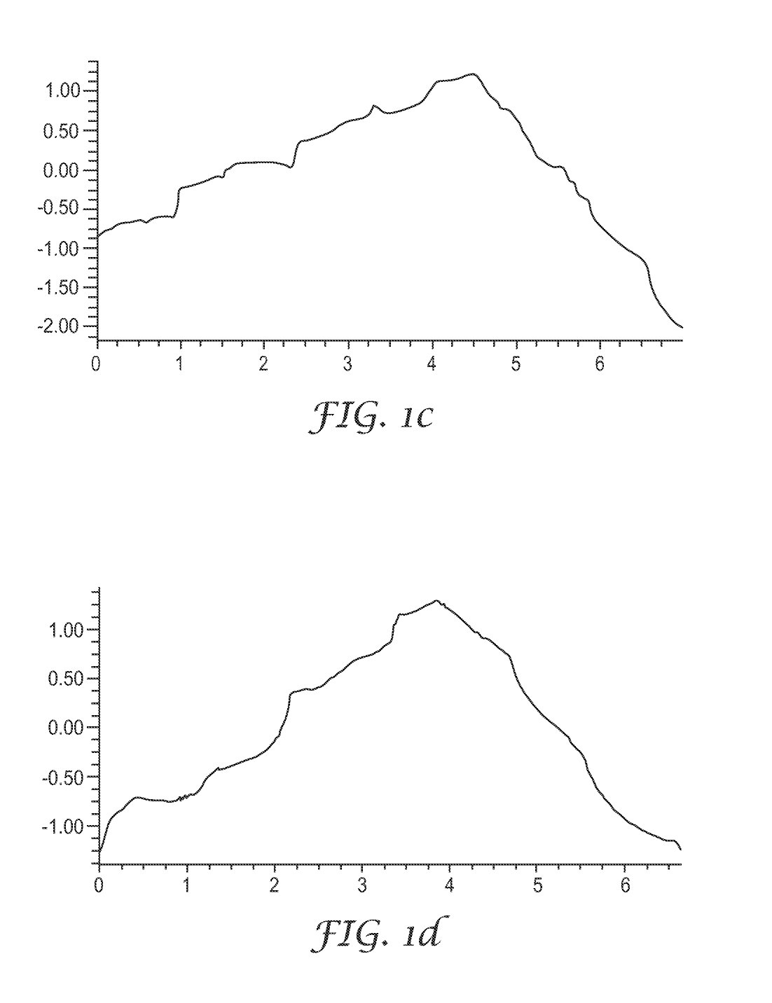

FIGS. 2a-2l, 3, 4a, and 4b illustrate representative embodiments of a construction for an optical article comprising a microstructured surface having randomly distributed recesses on the microstructured surface. It should be noted that these drawings are not to scale and that, in particular, the size of the recesses are exaggerated for illustrative purposes. The construction of the optical article can include combinations or two or more of the described embodiments below.

Optical article 11 includes an array of prisms typified by prisms 22, 24, 26, and 28, having recesses 14 randomly distributed on the prisms as illustrated in FIG. 2a. The recesses 14 and prisms are unitary, that is, the recesses are formed directly in the microstructure or prisms. Each prism, for example, such as prism 22, has a first facet 30 and a second facet 32. In this embodiment, the prisms 22, 24, 26, and 28 can be formed on a substrate 34 that has a first surface 36 on which the prisms are formed and a second surface 38 that is substantially flat or planar and opposite the first surface.

A linear array of regular right prisms can provide both optical performance and ease of manufacture. By right prisms, it is meant that the apex angle θ is approximately 90°, but can also range from approximately 50° to 150° or from approximately 80° to 100°. The prism facets need not be identical, and the prisms may be tilted with respect to each other. Furthermore, the relationship between the thickness 40 of the article and the height 42 of the prisms is not critical, but it is desirable to use thinner substrates with well defined prism facets. The angle that the facets can form with the surface 38 if the facets were to be projected can be 45°. However, this angle would vary depending on the pitch of the facet or the angle θ of the apex.

Referring to FIG. 2b, there is illustrated a representative cross-section of a portion of one embodiment of an optical article or light directing article. The article 130 includes a first surface 132 and an opposing microstructured surface 134 which includes a plurality of substantially linearly extending prisms 136 having randomly distributed recesses 137 in the prisms. Each prism 136 has a first side surface 138 and a second side surface 138′, the top edges of which intersect to define the peak, or apex 142 of the prism 136. The bottom edges of side surfaces 138, 138′ of adjacent prism 136 intersect to form a linearly extending groove 144 between prisms. In the embodiment illustrated in FIG. 2b, the dihedral angle defined by the prism apex 142 measures approximately 90 degrees, however it will be appreciated that the exact measure of the dihedral angle in this and other embodiments may be varied in accordance with desired optical parameters.

The microstructured surface 134 of article 130 may be described as having a plurality of alternating zones of prisms having peaks which are spaced at different distances from a common reference plane. The common reference plane may be arbitrarily selected. One convenient example of a common reference plane is the plane which contains first surface 132; another is the plane defined by the bottom of the lower most grooves of the microstructured surface, indicated by dashed line 139. In the embodiment illustrated in FIG. 2b, the shorter prisms measure approximately 50 micrometers in width and approximately 25 micrometers in height, measured from dashed line 139, while the taller prisms measure approximately 50 micrometers in width and approximately 26 micrometers in height. The width of the zone which includes the taller prism elements can measure between about 1 micrometer and 300 micrometers. The width of the zone that includes the shorter prisms is not critical and can measures between 200 micrometers and 4000 micrometers. In any given embodiment the zone of shorter prisms can be at least as wide as the zone of taller prisms. It will be appreciated by one of ordinary skill in the art that the article depicted in FIG. 2b is merely exemplary and is not intended to limit the scope of the present invention.

The width of the first zone can be less than about 200 to 300 micrometers. Under normal viewing conditions, the human eye has difficulty resolving small variations in the intensity of light that occur in regions less than about 200 to 300 micrometers in width. Thus, when the width of the first zone is reduced to less than about 200 to 300 micrometers, any optical coupling that may occur in this zone is not detectable to the human eye under normal viewing conditions.

Although an embodiment of this invention implements a variable height microstructured surface by varying the height of adjacent zones of prism elements, a variable height microstructured surface may also be implemented by varying the height of one or more prism elements along its linear extent to create alternating zones which include portions of prism elements having peaks disposed at varying heights above a common reference plane. Alternatively, these two features could be combined to produce a microstructured surface having alternating zones of relatively higher and lower peaks along both dimensions.

FIG. 2c illustrates another embodiment of the optical article similar to FIG. 2b except that the article 150 includes a microstructured surface 152 which has a zone of relatively shorter prisms 154 separated by a zone including a single taller prism element 156, each of the prisms having randomly distributed recesses 137. Much like the embodiment depicted in FIG. 2b, the taller prism limits the physical proximity of a second sheet of film to microstructured surface 152, thereby reducing the likelihood of a visible wet-out condition

FIG. 2d is a representative example of another embodiment of an optical article in which the prism elements are approximately the same size but are arranged in a repeating stair step or ramp pattern. The article 160 depicted in FIG. 2d includes a first surface 162 and an opposing microstructured surface 164 including a plurality of substantially linear prisms 166 having randomly distributed recesses 137. Each prism has opposing lateral faces 168, 168′ which intersect at their upper edge to define the prism peaks 170. The dihedral angle defined by opposing lateral faces 168, 168′ measures approximately 90 degrees. In this embodiment the highest prisms may be considered a first zone and adjacent prisms may be considered a second zone. Again, the first zone can measure less than about 200 to 300 micrometers.

FIG. 2e illustrates a further embodiment of an optical article. The article 180 disclosed in FIG. 2e includes a first surface 182 and an opposing microstructured surface 184 having randomly distributed recesses 137 on the microstructured surface. This article may be characterized in that the second zone which includes relatively shorter prism elements contains prism elements of varying height.

FIG. 2f shows another embodiment of an optical article for providing a soft cutoff FIG. 2f shows a brightness enhancement film, designated generally as 240, according to the invention. Brightness enhancement film 240 includes a base layer 242 and a microstructured surface 244 disposed on the substrate having randomly distributed recess 237 on the microstructured surface. Substrate 242 can generally be a polyester material and microstructured surface 244 can be an ultraviolet-cured acrylic or other polymeric material discussed herein. The exterior surface of base layer 242 is preferably flat, but could have structures as well. Furthermore, other alternative substrates could be used.

Microstructured surface 244 has a plurality of prisms such as prisms 246, 248, and 250, having randomly distributed recesses 237, formed thereon. Prisms 246, 248, and 250 have peaks 252, 254, and 256, respectively. All of peaks 252, 254, and 256 have peak or prism angles of preferably 90 degrees, although included angles in the range 60 degrees to 120 degrees. Between prisms 246 and 248 is a valley 258. Between prisms 248 and 250 is a valley 260. Valley 258 may be considered to have the valley associated with prism 246 and has a valley angle of 70 degrees and valley 260 may be considered the valley associated with prism 248 and has a valley angle of 110 degrees, although other values could be used. Effectively, brightness enhancement film 240 increases the apparent on axis brightness of a backlight by reflecting and recycling some of the light and refracting the remainder using prisms canted in alternating directions. The effect of canting the prisms is to increase the size of the output light cone.

FIG. 2g shows another embodiment of an optical article having rounded prism apexes. The optical article 330 features a flexible substrate 332 having a pair of opposed surfaces 334, 336, both of which are integrally formed with substrate 332. Surface 334 features a series of protruding light-diffusing elements 338. These elements may be in the form of “bumps” in the surface made of the same material as substrate 332. Microstructured surface 336 features an array of linear prisms having blunted or rounded peaks 340 integrally formed with substrate 332 and having randomly distributed recesses 337 on the microstructured surface. These peaks are characterized by a chord width 342, cross-sectional pitch width 344, radius of curvature 346, and root angle 348 in which the chord width is equal to about 20-40% of the cross-sectional pitch width and the radius of curvature is equal to about 20-50% of the cross-sectional pitch width. The root angle ranges from about 70-110 degrees, or from about 85-95 degrees, with root angles of about 90 degrees being preferred. The placement of the prisms within the array is selected to maximize the desired optical performance.

FIG. 2h shows another embodiment of an optical article having flat or planar prism apexes. The optical article 430 features a flexible substrate 432 having a pair of opposed surfaces 434, 436, both of which are integrally formed with substrate 432. Surface 434 features a series of protruding light-diffusing elements 438. These elements may be in the form of “flat bumps” in the surface made of the same material as layer 432. Microstructured surface 436 features an array of linear prisms having flattened or planar peaks 440 integrally formed with substrate 432 and having randomly distributed recesses 437 on the microstructured surface. These peaks are characterized by a flattened width 442 and cross-sectional pitch width 444, in which the flattened width can be equal to about 0-30% of the cross-sectional pitch width. FIG. 2i shows another embodiment of an optical article having a microstructured surface having randomly distributed recesses. Optical article 500 has a plurality of microstructures 502 having randomly distributed recesses 504 on the microstructured surface 508 and a smooth opposing surface 506 without microstructures. In this embodiment, the heights of the microstructure along their “peaks” vary continuously along their length. Similarly, the depths of the valleys between the “peaks” of the microstructure vary continuously. Alternatively stated, the distances from the “peak” lines or the valley lines of the microstructures on the microstructured surface 508, or from the microstructures themselves, to the plane associated with the opposing surface 506 vary continuously. In general, the actual heights of the structures, or the distances from the structures to the plane associated with opposing surface 506, vary between 2% and 12% and more preferably between 4% and 8% of the nominal or average height of the structures. The nominal or average period of the variations preferably should be between four and forty times the height of the structures. In another embodiment, the nominal period of the variations should be between five and sixteen times the nominal height of the structures. Desirably, the actual height varies by an amount and with a nominal period sufficient to substantially mask the small cosmetic defects typically encountered in the manufacturing process. Desirably, the actual height varies by an amount and with a nominal period sufficient to substantially mask cosmetic point or spot defects having maximum dimensions equal to or less than eight times or more preferably equal to or less than ten times the nominal height of the structures and most scratch defects.

FIG. 2j shows another embodiment of an optical article of the invention. Optical article 600 has a microstructured surface 602 having microstructures 604 and randomly distributed recesses 606 on the microstructured surface. In this embodiment, the microstructures have rounded “peaks” and valleys.

FIG. 2k shows a side view of an embodiment of optical article 700 including a substrate 702 and a microstructured surface 704 having randomly distributed recesses 706 on the microstructured surface. Microstructures 708 have “peaks” that vary in height along their lengths. Valleys indicated by dashed line 710 have a similar variation in depth.

FIG. 2l shows a cross-sectional view of another optical article of the invention. Optical article 800 has a light diverting microstructured surface 802 having randomly distributed recesses 806 on the microstructured surface and an opposing surface 803. In this embodiment, the light diverting microstructures 804 that have curved surfaces 808 and flat portions 810. The curved surfaces may be approximately by best-fit curves that have centers of curvature C1 and C2. In the illustrated embodiment, the flat portions 810 are parallel to the plane of the optical article 800. In some embodiments, the light diverting surface 802 may contain flat portions 812 between the light diverting microstructures 804. In the illustrated embodiment, the flat portions 430 are parallel to the plane of the optical article 800. Further embodiments of the microstructured surface of FIG. 2l are described in U.S. application Ser. No. 11/560,234, incorporated by reference in this application.

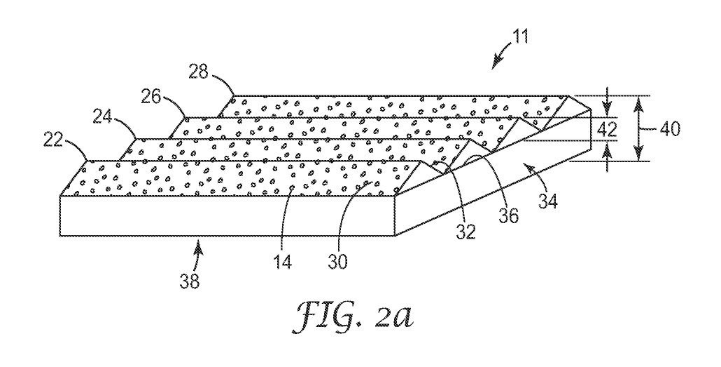

Optical article 1000 shown in FIG. 3 includes a microstructured surface 1002 on a substrate 1004 wherein the recesses 1006 are randomly distributed on the surface of the microstructured surface. In this embodiment, the microstructured elements 1008 are elongated prism structures with generally parallel grooves on the faces of the prism structures.

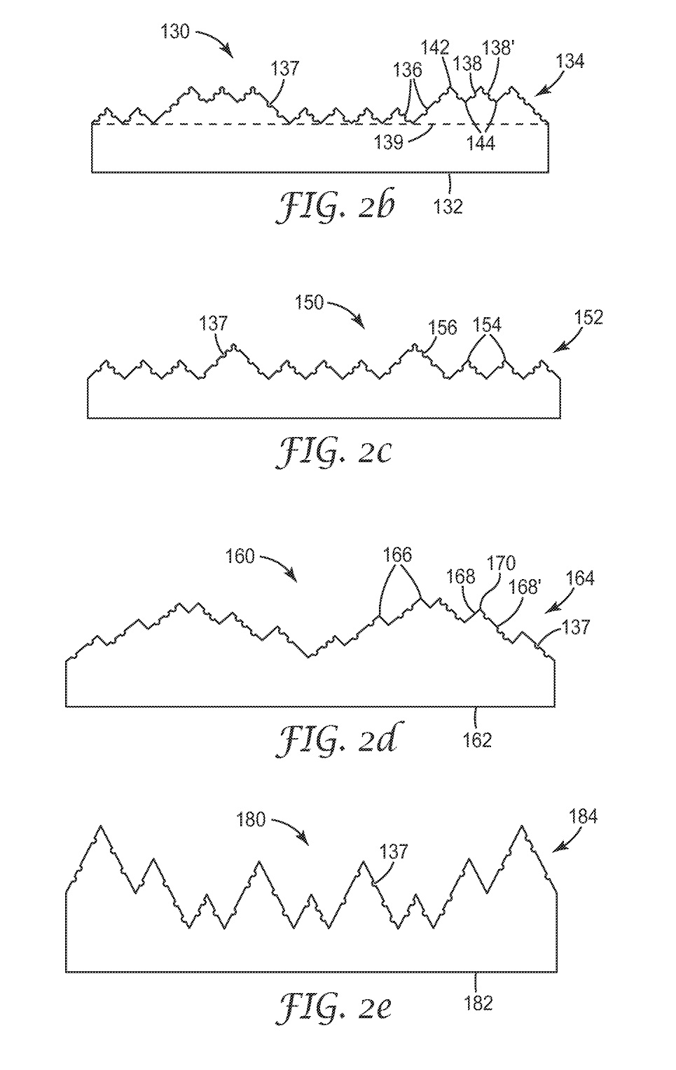

FIGS. 4a and 4b show a partial plan view and a cross section of optical article 1100 comprising a substrate 1108 having a microstructured surface 1104 having randomly distributed recesses 1102 on the discrete microstructured elements 1106. In this embodiment, the recesses are randomly distributed within a repeating pattern of discrete microstructures on a microstructured surface.

In another embodiment (not shown) the invention provides optical devices which utilize the optical articles of the invention. For example, an optical device may comprise a light source (e.g., one or more CCFLs, light emitting diodes, etc.), a light gating device (e.g., a liquid crystal display), and an optical article of the invention between the light source and the light gating device.

The recitation of numerical ranges by endpoint includes all numbers and ranges subsumed within that range (for example, 5-10 includes 5, 5.5, 6, 6.25, 7, 7.8, 8, 5.5-6.8, 5-9.25, 8.27, 9, 9.95, and 10).

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

### Example 1

An optical article according to the current invention was made as follows. A copper-plated steel roll was lathe-turned to create prism structures (with 90° apex angle, 45° base angles and 24 micrometer pitch) in continuous patterns around the circumference of the roll according to the method described in U.S. Pat. No. 6,354,709. The roll was then moved to a cleaning tank. The roll was rotated and washed with an alkaline cleaner (soap) solution at 150° F. (66° C.) for five minutes. The roll was then rinsed with deionized water (rated at 15-18 Megohms) at 165° F. (74° C.) for five minutes. Following this, the roll was deoxidized using a weak citric acid solution. The roll was again rinsed with deionized water at 165° F. (74° C.) for 30 seconds.

The roll was then transferred to a plating tank while still wet for electroplating with chrome. The plating tank contained a solution at a temperature of 124° F. (51° C.) consisting of 250 g/L of CrO₃, 2.5 g/L of 96% reagent grade sulfuric acid and deionized water. The anode for electroplating was platinized titanium. The distance between the anode and the surface of the roll was 25 mm. The current was then ramped up in 2 seconds to achieve a current density of 3.75 Amperes per square inch (0.58 Amperes per square cm). The roll was rotated at a face speed of 15 feet per minute (4.6 meters per minute), and 30% of the roll was immersed in the tank at any given time. As the roll rotated it was DC-plated for a total of 340 seconds. The roll was then sprayed by hose with deionized water. After rinsing the roll was dried.

The roll was then used as a tool to make film by means of a cast and cure process such as that described in U.S. Pat. No. 5,175,030. The substrate film was a polyethylene terephthalate (PET) film 2 mils (51 micrometers) in thickness and the resin used in the cast and cure process was a UV-curable acrylic resin suitable for optical use.

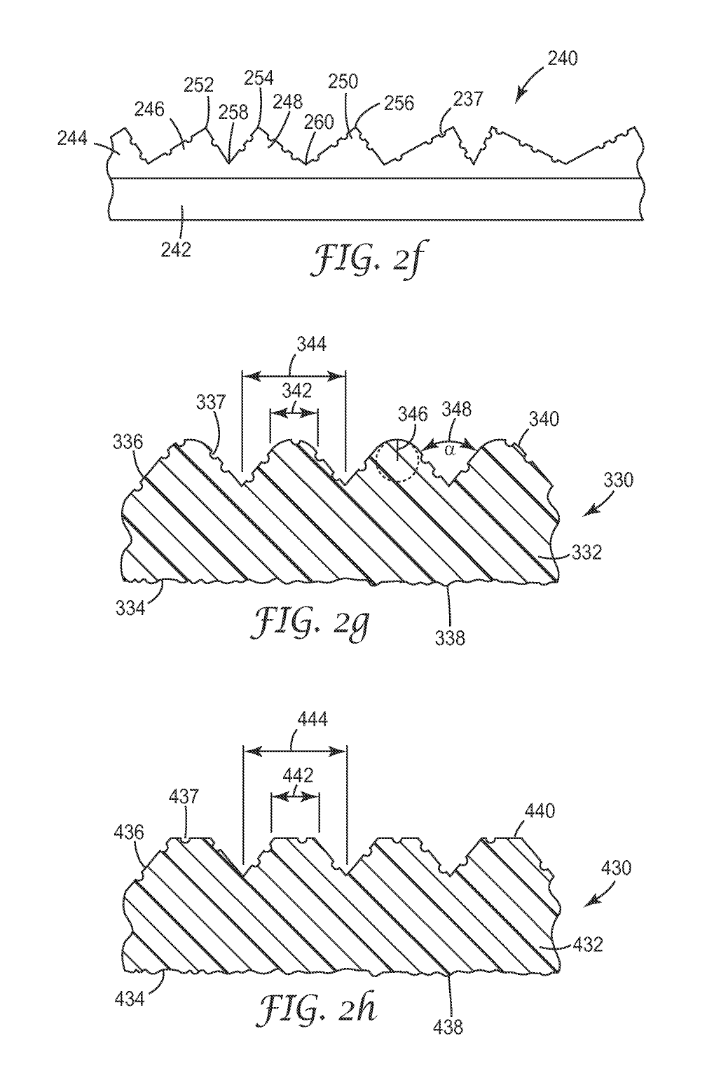

A digital image from a scanning electron microscope of a sample taken from the resulting film is shown as FIG. 5.

### Example 2

An optical article according to the current invention was made as in Example 1, with the following exceptions: the prism pitch was 50 micrometers, the current used in plating was ramped up in 25 seconds to achieve a current density of 8.5 Amperes per square inch (1.32 Amperes per square cm.), and the plating time was 170 seconds.

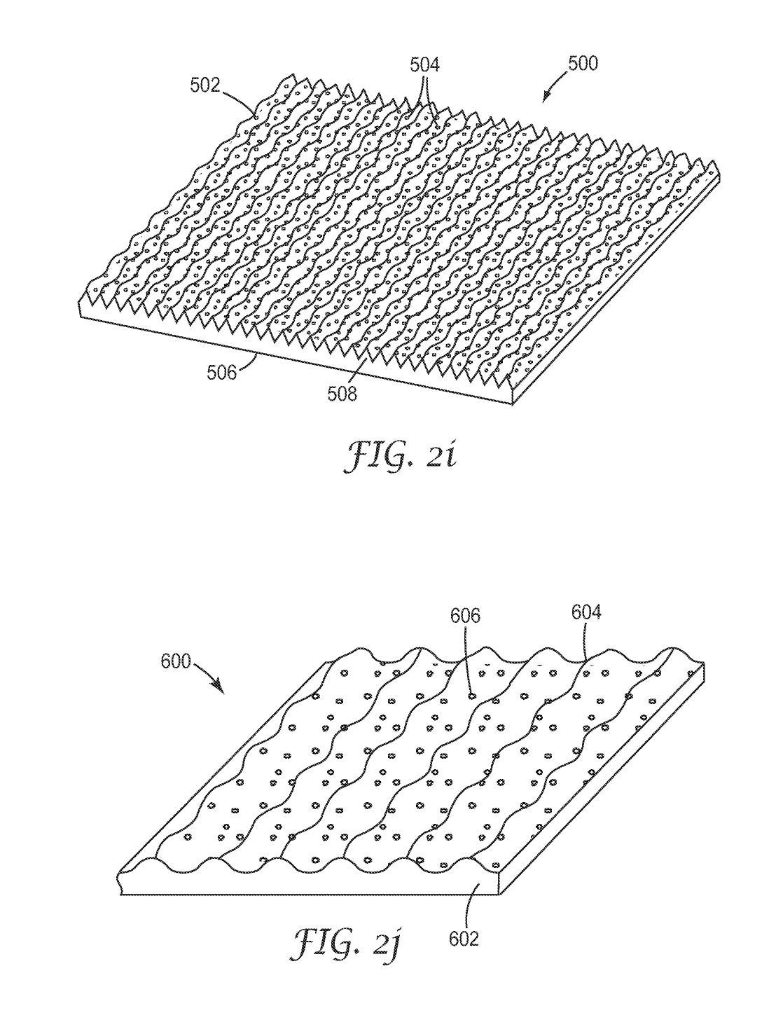

A digital image from a scanning electron microscope of a sample taken from the resulting film is shown as FIG. 6.

### Example 3

An optical article of the current invention was made as in Example 1, with the following exceptions: the prism pitch was 50 micrometers, the face speed during plating was 50 feet per minute (15.2 meters per minute), the current density was ramped up to 8.5 Amperes per square inch (1.32 Amperes per square cm.), and the plating time was 170 seconds.

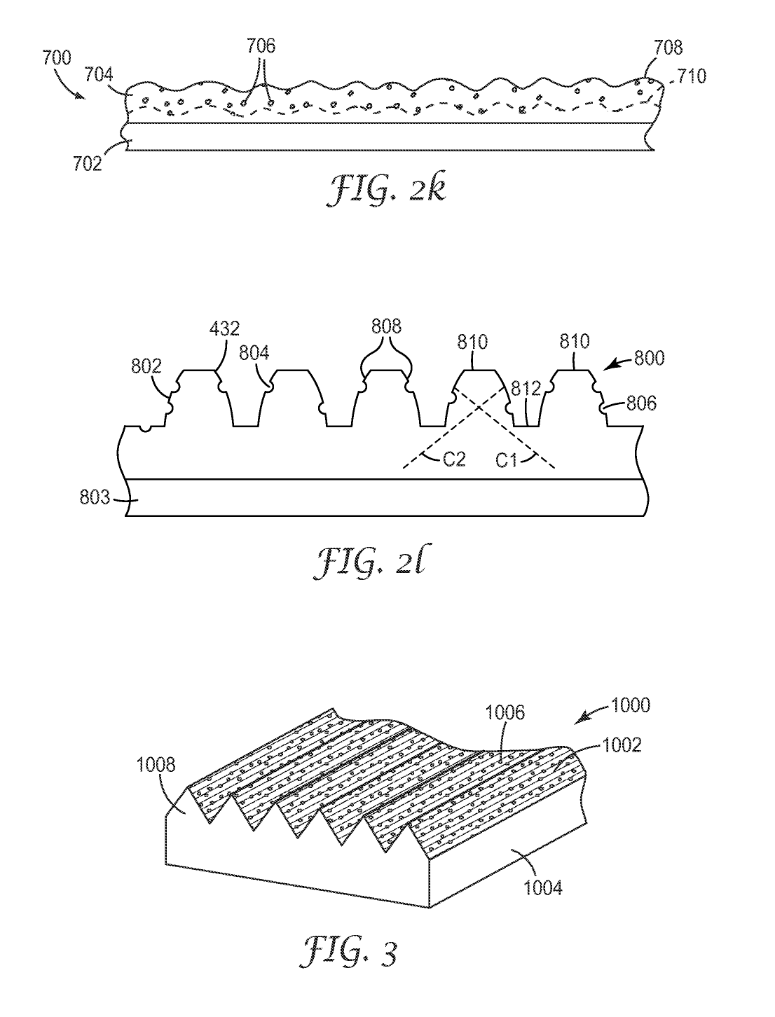

A digital image from a scanning electron microscope of a sample taken from the resulting film is shown as FIG. 7.

### Example 4

An optical article of the current invention was made as in Example 1, with the following exceptions: the prism pitch was 50 micrometers, the current for plating was ramped up to 1.5 Amperes per square inch (0.23 Amperes per square cm.) in 25 seconds, and the plating time was 450 seconds.

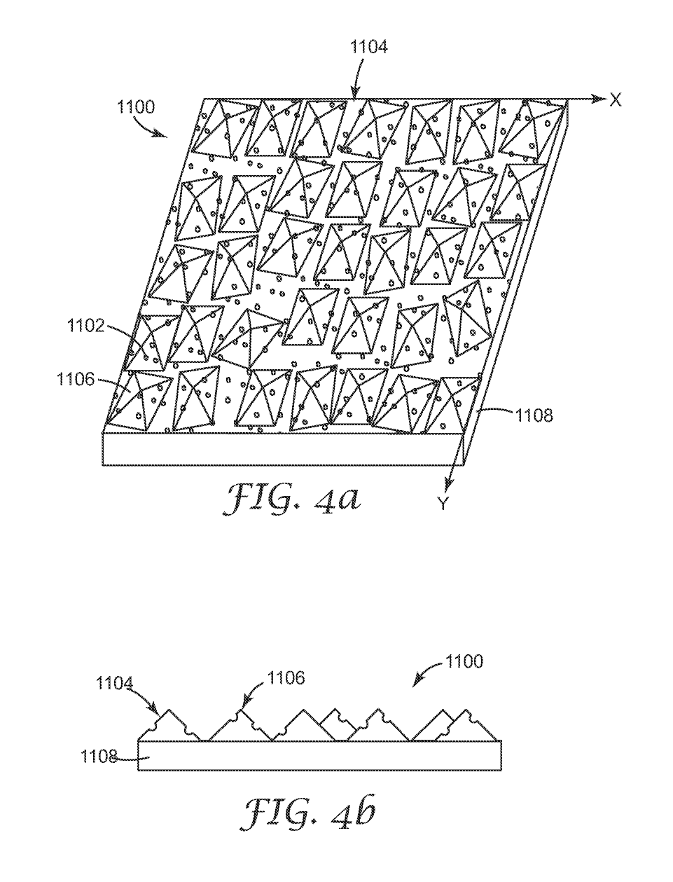

A digital image from a scanning electron microscope of a sample taken from the resulting film is shown as FIG. 8.

### Example 5

An optical article according to the current invention was made as follows. A copper-plated steel roll was lathe-turned to create prism structures as shown in FIG. 2l; with a peak height of 17 um and a pitch of 57.4 um in continuous patterns around the circumference of the roll according to the method described in U.S. Pat. No. 6,354,709. The roll was then moved to a cleaning tank. The roll was rotated and washed with an alkaline cleaner (soap) solution at 150° F. (66° C.) for five minutes. The roll was then rinsed with deionized water (rated at 15-18 Megohms) at ambient temperature for five minutes. Following this, the roll was deoxidized using a weak citric acid solution. The roll was then again rinsed with deionized water at ambient temperature for 30 seconds.

The roll was then transferred to a plating tank while still wet for electroplating with chrome. The plating tank contained a solution at a temperature of 124° F. (51° C.) consisting of 250 g/L of CrO₃, 2.5 g/L of 96% reagent grade sulfuric acid and deionized water. The anode for electroplating was platinized titanium. The distance between the anode and the surface of the roll was 45 mm. The current was then ramped up in 5 seconds to achieve a current density of 4.4 Amperes per square inch (0.68 Amperes per square cm). The roll was rotated at a face speed of 15 feet per minute (4.6 meters per minute) and 30% of the roll was immersed in the tank at any given time. As the roll rotated it was DC-plated for a total of 300 seconds. The roll was then sprayed with deionized water. After rinsing the roll was dried.

The roll was then used as a tool to make film by means of a cast and cure process such as that described in U.S. Pat. No. 5,175,030. The substrate film was PET film with a thickness of 5 mils (127 micrometers) and the resin used in the cast and cure process was the same acrylic resin used in Example 1.

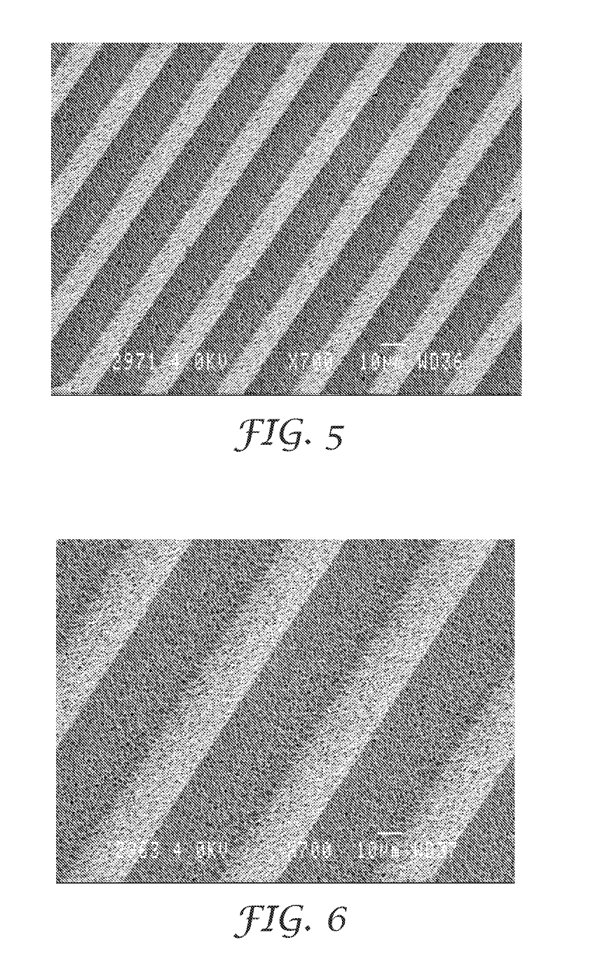

A digital image from a scanning electron microscope of a sample taken from the resulting film is shown as FIG. 9.

A section of size 16″ by 28″ (40.6 cm by 71.1 cm) was then cut from the optical article in order to measure the effect of an optical article of the invention on the optical uniformity of a film stack. A test fixture for uniformity testing was assembled as follows. First, a reflector plate (obtained from a 32″ Sony TV model KDL-3253000) was placed underneath sixteen cold cathode fluorescent light (CCFL) bulbs (obtained from the same Sony TV)), each 3 mm in diameter. Center-to-center spacing of the bulbs was 23.7 mm. The bulbs were held above the reflector by three plastic supports running perpendicular to the long axis of the bulbs. The distance from the center of the bulb to the reflector was 5.0 mm. Pins held a 2 mm clear acrylic plate (available from Cyro Industries, Parsippany N.J.) 9.5 mm above the CCFL bulb centers. Immediately above and adjacent to the clear plate was the optical article of this example. Immediately above and adjacent to this was a beaded diffuser sheet (obtained from the 32″ Sony TV model KDL-3253000). Above and adjacent to the diffuser sheet was a sheet of brightness enhancing film (available as BEF-III 10T from 3M Company, St. Paul Minn.). Above and adjacent to this was another diffuser sheet also of the kind described above.

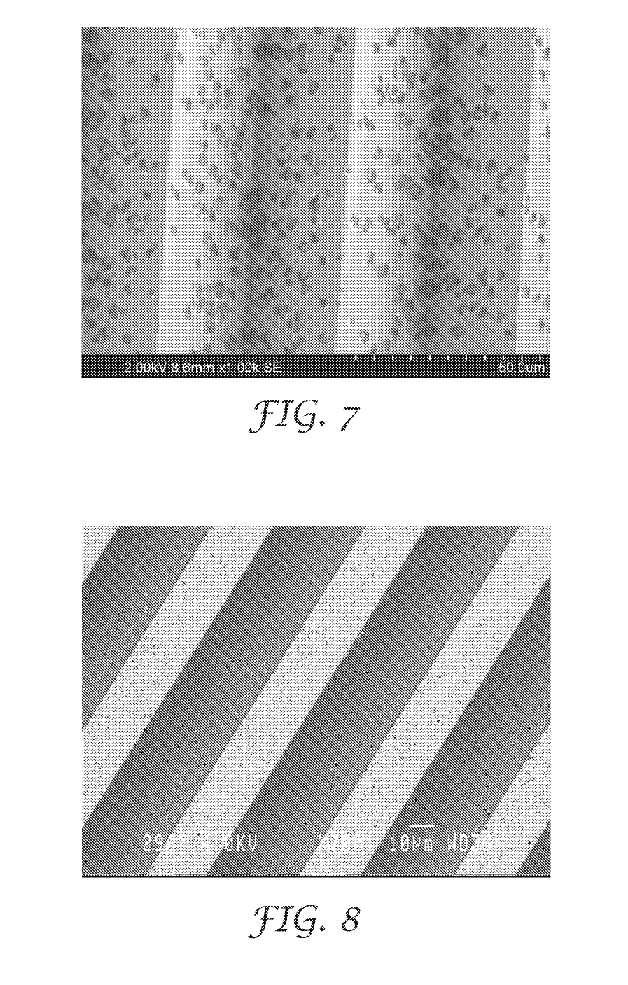

Optical data corresponding to this film stack were collected using a CCD imaging photometer, radiometer and colorimeter (available as Model PM-1613F from Radiant Imaging Inc., Duvall, Wash.). The CCD camera provided data on brightness versus position on the film stack. Uniformity values were calculated from raw data as follows: first, the positional data were averaged in a direction perpendicular to the long axis of the bulbs in order to provide an average cross-section for the usable area of the test bed. Then a rolling average of this cross-section data was subtracted from the original cross-sectional data to show oscillations of the data across the test fixture. Uniformity as a relative luminance value was then calculated as a standard deviation of the oscillations divided by the average brightness and reported as a percentage. A plot of the results is shown in FIG. 10a as line 1200. The horizontal axis is a measure of relative position across the face of the film stack, and the vertical axis is the computed oscillation of relative luminance value described above.

For comparison, measurements were also taken with the same test fixture and a standard film stack consisting of the following elements: a 2 mm thick diffuser plate (acquired from a 40″ Sony TV model KDL-40XBR4) sat on pins above the reflector plate and CCFL bulbs. Immediately above and adjacent to the plate was a diffuser sheet as described above. Immediately above and adjacent to this sheet was a sheet of BEF III 10T as described above. Above and adjacent to this was another diffuser sheet also of the kind described above Measurements were taken for this film stack and relative luminance values were computed as before. The results are also plotted in FIG. 10a as line 1202.

### Example 6

An optical article according to the current invention was made as in Example 5, with the following exceptions: the current was ramped up to achieve a current density of 3.4 Amperes per square inch (0.53 Amperes per square cm.), and the plating time was 380 seconds.

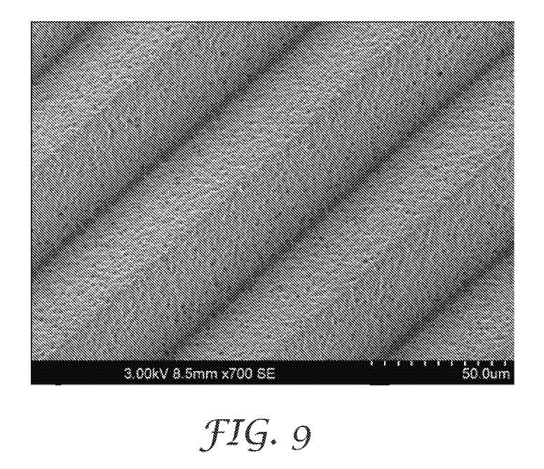

A digital image from a scanning electron microscope of a sample taken from the resulting film is shown as FIG. 11.

A section of size 16″ by 28″ (40.6 cm by 71.1 cm) was then cut from the optical article in order to measure the effect of an optical article of the invention on the optical uniformity of a film stack. The film stack was prepared as in Example 5 except that the optical article of this example replaced the optical article of Example 5. Measurements were taken and relative luminance values were computed as in Example 5. The results are plotted in FIG. 10B as lines 1300 (Example 6) and 1202.

### Example 7

An optical article according to the current invention was made as follows. A copper-plated steel roll was lathe-turned to create structures as shown in FIG. 2l with a peak height of 17 micrometers and a pitch of 57.4 micrometers in continuous patterns around the circumference of the roll according to the method described in U.S. Pat. No. 6,354,709. The roll was then moved to a cleaning tank. The roll was rotated and washed with an alkaline cleaner (soap) solution at 130° F. (54° C.) for five minutes. The roll was then rinsed with deionized water (rated at 15-18 Megohms) at room temperature for five minutes. Next the roll was deoxidized for 90 seconds at 75° F. (24° C.) with a sulfuric acid solution consisting of 1% by volume of 96% reagent grade sulfuric acid in deionized water. The roll was then rinsed with deionized water at room temperature for 45 seconds.

The roll was then transferred to a plating tank while still wet for electroplating with copper. The plating tank contained a solution at a temperature of 25° C. consisting of copper at 53.5 g/L provided via liquid copper sulfate, 60 g/L of 96% reagent grade sulfuric acid, 60 mg/L of chloride ions (obtained as 37% reagent hydrochloric acid) and the balance was deionized water (rated at 15-18 Megohms). The copper bath was treated with carbon to remove organic contamination and checked for purity by Hull Cell analysis. The anode consisted of copper anode nuggets (0.040 to 0.065% phosphorus by weight, of dimensions 0.55 in×0.55 in (1.4×1.4 cm), available from IMC Corporation, Jenkintown, Pa.) The distance between the anode and the surface of the roll was 45 mm. The current was ramped up in 5 seconds to achieve a current density of 30 amperes per square foot (32.3 milliamps per square cm). The roll was rotated at 50 rpm and 50% of the roll was immersed in the tank at any given time. As the roll rotated it was DC-plated for a total of 15 minutes. The roll was then rinsed by with deionized water.

Following this, the roll was transferred to a cleaning tank. The roll was rotated at 10 rpm while being washed with about 1 liter of deionized water at ambient temperature from a hose with a spray nozzle. The roll was then washed with a weak citric acid solution. Next the roll was washed with approximately one liter of deionized water to remove excess citric acid. Then the roll was washed with 0.5 liters of denatured ethyl alcohol at ambient temperature, applied slowly from to cover the entire roll surface. Then the roll was air dried.

Following this, the roll was moved into a cleaning tank. The roll was rotated at 20 rpm and washed with an alkaline cleaner solution at 150° F. (66° C.) for 5 minutes. The roll was then rinsed with deionized water (rated at 15-18 Megohms) at room temperature for 5 minutes. Next the roll was deoxidized using a weak citric acid solution at 150° F. (66° C.) for one minute. The roll was then rinsed with deionized water at room temperature for 30 seconds.

Next the roll was transferred to a chrome plating tank while still wet. The composition of the chrome bath was as described in Example 5. A platinized titanium anode was used and the spacing between anode and the surface of the roll was 25 mm. The current was ramped up at a rate of 600 amperes/second to achieve a current density of 2.5 Amperes per square inch (0.39 Amperes per square cm). The AC current ripple was held to less than 5% at the roll. The roll was rotated at 90 rpm and 30% of the roll was immersed in the tank at any given time. As the roll rotated it was DC-plated for 90 seconds. The roll was then removed from the plating bath and rinsed with deionized water to wash away the chrome bath.

Following this, the roll was transferred to a cleaning tank where it was rotated at 10 rpm. While rotating the roll was washed with one liter of deionized water at ambient temperature using a spray bottle. Then the roll was washed slowly with 1.5 liters of denatured ethyl alcohol, using a spray bottle to cover the entire roll surface. The roll rotation speed was then increased to 20 rpm and the roll was air dried.

The roll was then used as a tool to make film by means of a cast and cure process such as that described in U.S. Pat. No. 5,175,030. The substrate film was 10 mil (254 micrometers) thick PET film and the resin used in the cast and cure process was a UV-curable acrylic resin suitable for optical use.

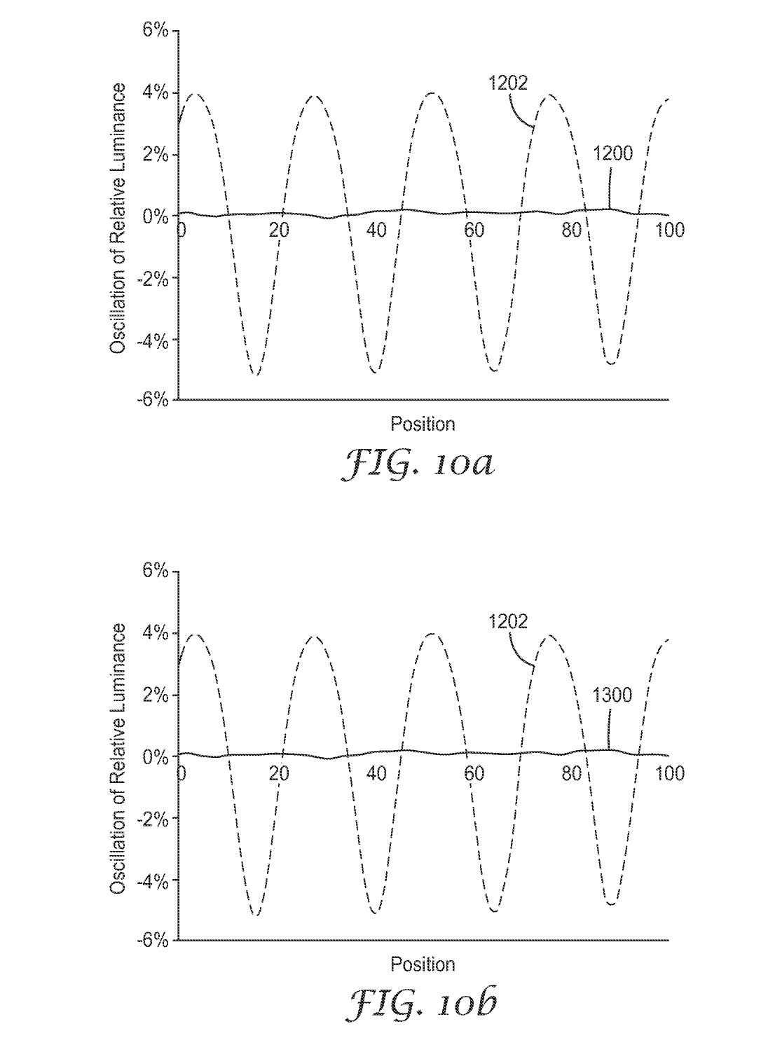

A digital image from a scanning electron microscope of a sample taken from the resulting film is shown as FIG. 12.

### Example 8

An optical article according to the current invention was made as in Example 7, with the following exceptions: the structures that were lathe-turned into the roll were prisms with an apex angle of 90°, base angles of 45°, and pitch of 50 micrometers. During copper plating, the roll was rotated at 90 rpm, and the roll was DC-plated at a current density of 60 Amperes per square foot (64.6 milliAmps per square cm.).

In addition, the substrate used to make the article was a 5 mil (127 micrometers) thick PET film and the resin used was the same acrylic resin used in Example 1

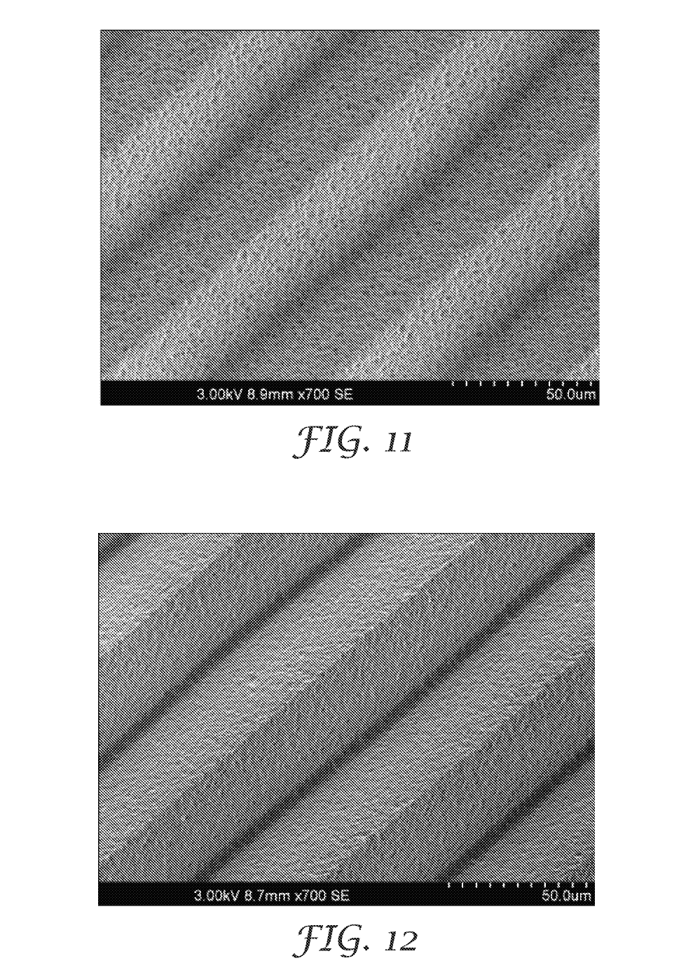

A digital image from a scanning electron microscope of a sample taken from the resulting film is shown as FIG. 13.

### Example 9

An optical article of the current invention was made as in Example 7, with the following exceptions: the structures that were lathe-turned into the roll were prisms with an apex angle of 90°, base angles of 45°, and pitch of 50 micrometers. During copper plating, the roll was DC-plated at a current density of 60 Amperes per square foot (64.6 milliAmps per square cm.), and the plating time was 30 minutes.

In addition, the substrate used to make the article was a 6.9 mil (175 micrometers) thick PET film.

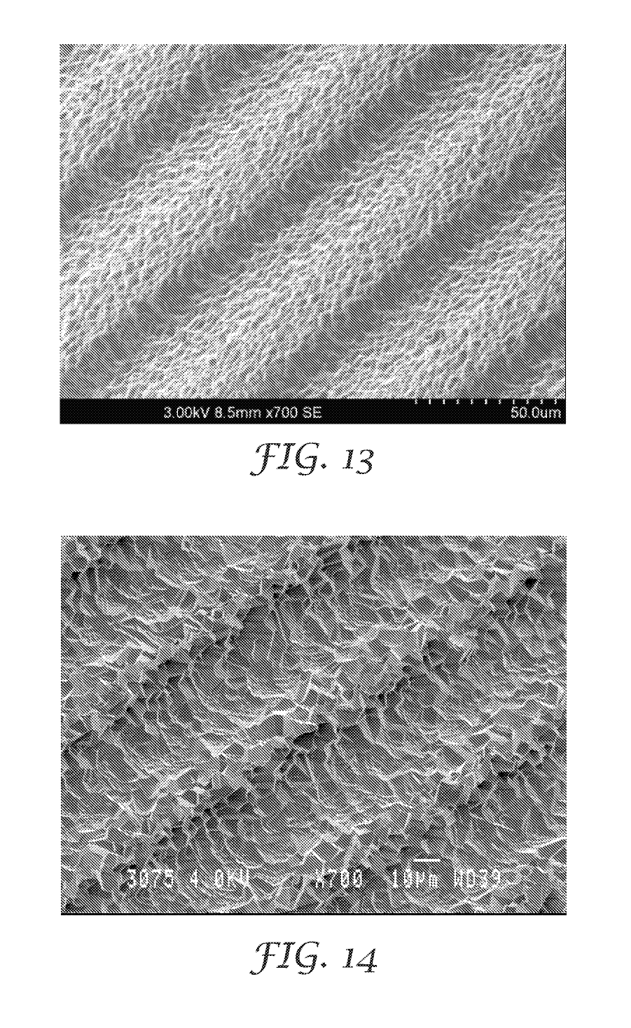

A digital image from a scanning electron microscope of a sample taken from the resulting film is shown as FIG. 14.

### Example 10

An optical article of the current invention was made as in Example 7, with the following exceptions: during copper plating, the roll was DC-plated at a current density of 60 amperes per square foot (64.6 milliamps per square cm.), and the plating time was 30 minutes.

In addition, the substrate used to make the article was a PET film with a thickness of 6.9 mils (175 micrometers).

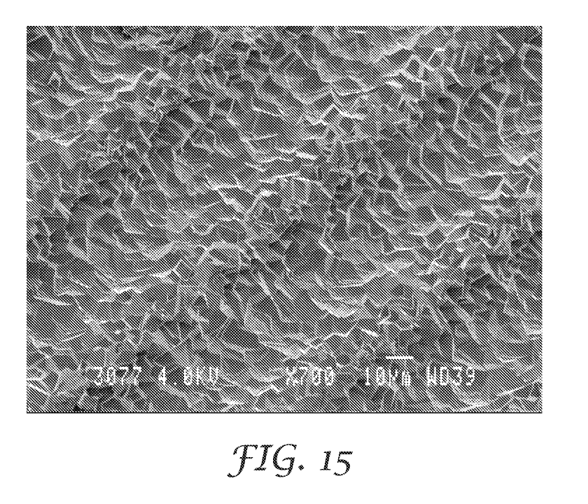

A digital image from a scanning electron microscope of a sample taken from the resulting film is shown as FIG. 15.

What is claimed is:

1. An optical article, comprising:
an optical film comprising a substrate having a microstructured surface, the microstructured surface having randomly distributed recesses on the microstructured surface, wherein the microstructured surface and the recesses are unitary.

2. The optical article of claim 1, wherein the randomly distributed recesses are random within a repeating pattern.

3. The optical article of claim 1, wherein the substrate comprises a material selected from the group consisting of styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, glass, and combinations of any of them.

4. The optical article of claim 1, wherein the microstructured surface comprises a material selected from the group consisting of acrylates, methacrylates, polycarbonates, polyurethanes, epoxies, urethane acrylates, polyesters, poly(alkane terephthalates), PET and PEN copolymers, and combinations thereof.

5. The optical article of claim 1, wherein the substrate comprises multiple film layers.

6. The optical article of claim 1, wherein the microstructured surface comprises linear microstructures, random microstructures, pseudo-random microstructures, discrete microstructures, or canted microstructures.

7. The optical article of claim 1, wherein the substrate has a coated surface opposite the microstructured surface.

8. The optical article of claim 7, wherein the coated surface comprises a bead coating.

9. The optical article of claim 1, wherein the substrate has a substantially planar surface opposite the microstructured surface.

10. The optical article of claim 1, wherein the microstructured surface comprises prisms, linear prisms, asymmetric prisms, truncated prisms, and light diverting elements having curved surfaces and flat portions.

11. The optical article of claim 1, wherein diameters of the recesses range from about 0.5 micrometers to about 125 micrometers.

12. The optical article of claim 1, wherein depths of the recesses range from 0.2 to about 10 micrometers.

13. The optical article of claim 1, wherein the shape, size, and distribution of the recesses are replicated from chromium or copper structures deposited on a replication tool.

14. The optical article of claim 1, wherein the microstructures surface comprises microstructures and the microstructures have equal heights.

15. The optical article of claim 1, wherein the substrate and the microstructured surface are monolithic.

16. The optical article of claim 1, wherein the microstructured surface and the substrate are separate layers bonded together.

17. The optical article of claim 1, wherein the substrate incorporates diffusive particles.

18. An optical display, comprising:
a light source;
a light gating device; and
an optical article of claim 1, for directing light from the light source to the light gating device.

19. The optical display of claim 18, wherein the light gating device is a liquid crystal display.
